(19) United States
(12) Patent Application Publication
(10) Pub. No.: US 2024/0072897 A1
(43) Pub. Date: Feb. 29, 2024

(54) APPARATUS AND METHODS FOR FIBER OPTIC BI-DIRECTIONAL LOCAL AREA NETWORKS

(71) Applicant: Panduit Corp., Tinley Park, IL (US)

(72) Inventors: Bulent Kose, Burr Ridge, IL (US); Jose M. Castro, Naperville, IL (US); Yu Huang, Orland Park, IL (US)

(73) Assignee: Panduit Corp., Tinley Park, IL (US)

(21) Appl. No.: 17/899,688

(22) Filed: Aug. 31, 2022

(51) Int. Cl. H04B 10/25; H04J 14/02

(52) U.S. Cl. CPC H04B 10/2589; H04J 14/02

(57) ABSTRACT

A system for implementing Bi-Di fiber optic LAN has a plurality of optical channels being transmitted over a same optical fiber by using wavelength division multiplexing and wherein at least one of the optical fiber channels have bi-directional transmission. The system also has an access network side located in at least one of a zone distribution area or zone box, access network side cabling distributed across diverse physical distances with individual cable runs; and optical Ethernet transceivers that do not require the high transmitting optical power and high receiver sensitivity typically.

### FIELD OF INVENTION

The present invention relates to the field of optical Local Area Network (LAN), and more specifically, to Bi-Directional (Bi-Di) CWDM optical LANs.

### BACKGROUND AND PRIOR ART EVALUATION

Traditional enterprise networks have used copper connectivity such as UTP Cat. 5, 6, or 6A or coaxial for Distributed Antenna Systems (DAS). However, copper connectivity limits the network distances to 100 m and has reached the point where achieving efficient transmission at data rates beyond 10 G over 100 m of the copper cable becomes impractical.

Since the last decade, enterprise networks have been experiencing an accelerated migration from wired to wireless connections. It is expected that before 2025, more than 95% of enterprise traffic will be carried by wireless access. Newer wireless access points (WAP) require more extended and high-bandwidth channels. For example, WiFi6 can require a wired transmission of 10 G to the (WAPs). In addition, newer generation of wireless access (WiFi7) and deployment of newer cellular bands in 5 G (e.g., NR) will impose challenges to DAS using coaxial media.

Under this trend, the performance of the copper-based cabling could limit future growth in terms of data rates or reaches. Therefore, many businesses need to upgrade their local area networks (LAN) and campus networks to remain competitive.

Optical networks can provide secure and virtually limitless bandwidth for very long distances that can cover the requirement of premises and campus networks from core to access layers. Passive Optical Networks, a Time Division Multiplexing (TDM) based fiber-optic telecommunications technology used for delivering broadband network access to end-customers, can also be utilized for enterprise LAN. Passive Optical LANs (POL) could provide significant value for some enterprises since their implementation can offer longer distances than copper channels, an efficient way to provide access to many users. Also, POL can save CAPEX and OPEX using a passive distribution layer and cables with a smaller diameter that facilitates the network installation. Nevertheless, POL has some disadvantages compared with traditional point-to-point optical LAN in terms of bandwidth, latency, and security. The limitations on bandwidth compared with conventional optical LAN are caused by: Bandwidth sharing with many users based on TDM, the slower development of POL standards relative to Ethernet, the long gap between standard release and availability in the market, and the way POL operates.

Although the provided bandwidth by POL could be enough for some users in verticals such as hospitality, school, and small libraries, some enterprise networks might find the bandwidth and latency provided by POL unacceptable.

The inventors of this application found that the advantages provided by POL, such as faster and less complex deployment using smaller cables, bi-directional transmission that further reduces the number of installed fibers by half, and the passive distribution layer, can also be achieved by Ethernet networks using the apparatus and methods described in this application. This discusses implementing bi-directional transmission over the passive CDWM optical network. Using wavelength channels, multiple applications can be implemented over the same passive physical infrastructure, such as active point to point Ethernet, POL, and DAS for cellular communication networks. FIG. 1 shows a duplex implementation of 16 channel CWDM for active point to point Ethernet in which transmit and receive channels utilize separate CWDM mux/demux.

### SUMMARY

A system for implementing Bi-Di fiber optic LAN has a plurality of optical channels being transmitted over a same optical fiber by using wavelength division multiplexing and wherein at least one of the optical fiber channels have bi-directional transmission. The system also has an access network side located in at least one of a zone distribution area or zone box, access network side cabling distributed across diverse physical distances with individual cable runs; and optical Ethernet transceivers that do not require the high transmitting optical power and high receiver sensitivity typically.

### BRIEF DESCRIPTION OF THE FIGURES

FIG. 1 shows a duplex implementation of 16 channel CWDM for active point to point Ethernet in which transmit and receive channels utilize separate CWDM mux/demux.

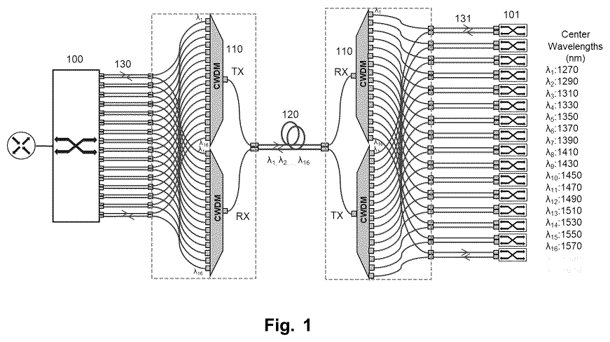

FIG. 2 shows an example of 16-channel point to point CWDM LAN.

FIG. 3 shows the equivalence of use of 3-port broadband circulators to the use of a combination of a broadband isolator and 1×2 50/50 splitter.

FIG. 4 shows a second embodiment: 16 channel CWDM LAN configuration using 4×16 channel CWDM modules, and 2× broadband circulators.

FIG. 5 shows a third embodiment: 16 channel CWDM LAN configuration using 3×16 channel CWDM modules, and one broadband circulator.

FIG. 6. Shows a fourth embodiment: 8 channel Bi-Di CWDM LAN configuration using 2×16 channel CWDM modules, and 16×1×2 CWDM modules.

FIG. 7 shows a fifth embodiment: 8 channel Bi-Di CWDM LAN configuration using a new type of CWDM module proposed: 8 channel 40 nm channel spacing.

### DESCRIPTION OF INVENTION

POL has been proposed for enterprise networks since it can offer longer distances than copper channels, it's an efficient way to provide access to many users, and it's installation flexibility. However, POL has disadvantages in bandwidth and latency compared with traditional Ethernet optical LAN. Therefore, it is not the best option for enterprises interested in future-proof infrastructure required for the fastest wireless access points such as WiFi 7.

Optical Ethernet networks used in today's data center can provide the required bandwidth for future enterprises. However, they require either an active distribution layer or point-to-point connections to the devices. For some enterprise networks with long distances or many interconnecting devices, point-to-point interconnections can be costly to implement.

In this invention, the authors disclose methods for fiber optic Bi-Di LAN configurations utilizing CWDM. The authors also disclose apparatus that enclose various fiber optical components to be used in Bi-Di LANs.

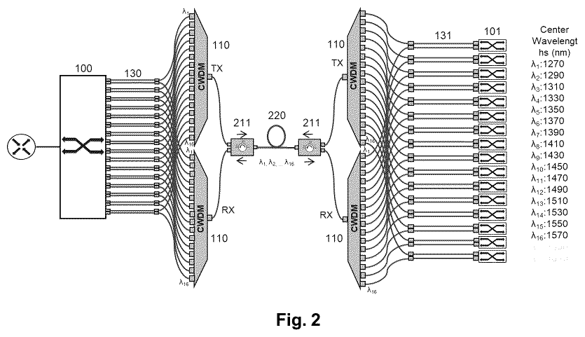

The first embodiment is shown in FIG. 2 as an example of 16-channel point to point CWDM LAN.

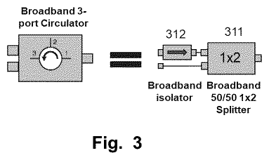

Access switches, 101, are connected to core switch ports, 100, point-to-point over CWDM. According to the figure, only the trunk cable is used as Bi-Di in this method. Two separate 16-channel CWDM modules, 110, are used on either side of the LAN, core, and access. One CWDM module is used for transmitting, and the other is used for receiving, where wavelength ports are combined together at the module interface to form duplex connector, e.g., for equipment patch cord connection at the core network side. Broadband circulators, 211, are used to combine and separate the forward and reverse traveling signals. According to availability of current ITU CWDM wavelength grid, 18 channels are possible, and each channel can run multitude of Ethernet transmission speeds, 1 G, 10 G, 25 G, and other applications such as DAS and various PON applications can run on these wavelength channels as well. The LAN configuration disclosed in FIG. 2 can be constructed using other fiber optic components replacing the 3-port circulators. A combination of broadband isolator and broadband 50/50 1×2 splitter is functionally equivalent to an isolator except for some variations of the insertion loss (IL), return loss (RL) and other optical parameters. The circulators, 211, in FIG. 2 can be replaced by the isolator/splitter combination in FIG. 3.

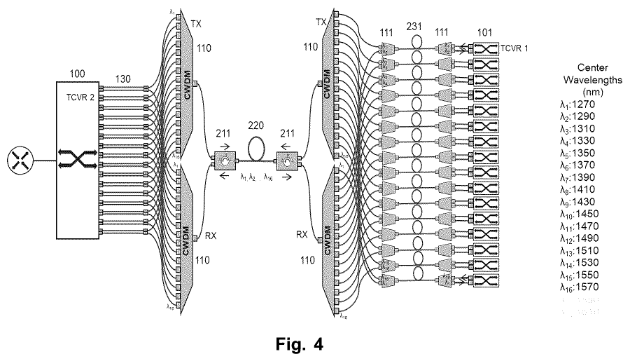

In embodiment 2, as shown in FIG. 4, the access side cabling, 231, is also used in Bi-Di mode by mixing the core and access side transceiver (wavelength) combinations. Wavelength ports from access side RX CWDM module are combined with access side TX CWDM wavelength ports onto 1×2 CWDM modules, 111. What this means is, for example TCVR 2 in core switch is connected to TCVR 1 in access switch according to the mixing method shown in FIG. 4. There are many combination options, however the one shown in FIG. 4 is just an example, which also is a practical one because of mixing neighboring wavelengths (transceivers). As in the case of embodiment 1, the circulators, 211, can be replaced with isolator/splitter combination in FIG. 3. For embodiment 2, the 1×2 CWDMs, 111, can be replaced by circulator, 211, or isolator/splitter combinations of FIG. 3. If this is done, then the port mixing would not be needed anymore.

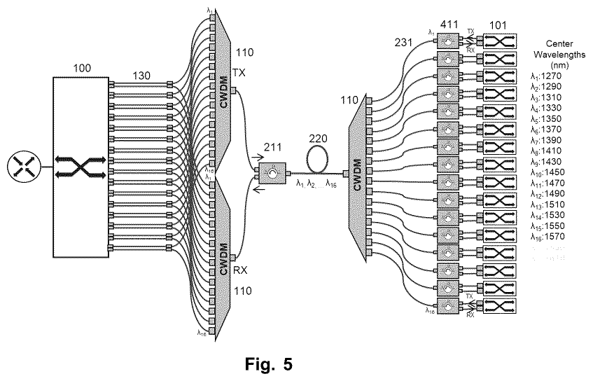

In embodiment 3, shown in FIG. 5, a single 16 channel CWDM module is used at the access network side, which allows the access cabling to be used in Bi-Di mode. Individual narrowband circulators, 411, are used before the access switch transceivers to separate the transmit and receive signals. This method increases the use of circulators, but it is to be noted that these circulators do not need to be broadband, therefore they can be cost effective and practical. Another benefit of this embodiment is one of the broadband circulators and one of the 16 channels CWDM modules are not needed, therefore making this embodiment another viable method. Embodiment 3 can be configured to replace the wideband and narrowband circulators with isolator/splitter combinations.

Embodiments 1, 2 and 3 in FIGS. 2, 4 and 5 respectively can be configured to have any number of channels, up to 18 channels, as allowed in ITU CWDM grid. These embodiments as depicted in FIGS. 2, 4 and 5 also indicate that core side cabling does not need to be in Bi-Di mode. Normally, LAN structured cabling best practices would allow this construction most of the time, because the core side optical modules such as CWDM modules can be physically located near the core switches, therefore normal duplex patch cabling can be used. In case the core side cabling is also needed to be Bi-Di, the approaches of using circulators or isolator/splitter combinations can be easily applied to core side cabling as well. The authors of this invention assume that this is a trivial part of the disclosed LAN configurations depicted in FIGS. 2, 4 and 5.

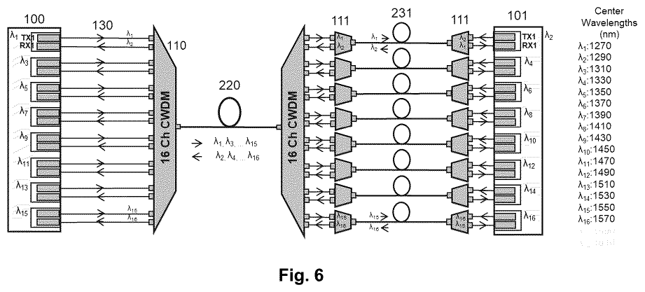

Embodiment 4, as shown in FIG. 6, is a simpler option where transceivers with different wavelengths are used at core and access side, therefore the use of CWDM filter components is sufficient to configure the CWDM LAN, and more optically complex components such as circulators and isolators are not needed. This is advantageous for construction, but the price to pay is the reduced number of channels possible in these configurations.

The example configuration in In FIG. 6, shows using odd numbered wavelengths at core transceivers and even numbers at access. This is just and example, in reality any wavelength/transceiver combinations can be used as long as those wavelengths are connected to correct CWDM module ports. Although not necessary, the 1×2 CWDM modules, 111, can be replaced by narrowband circulators or narrowband isolator/splitter combinations.

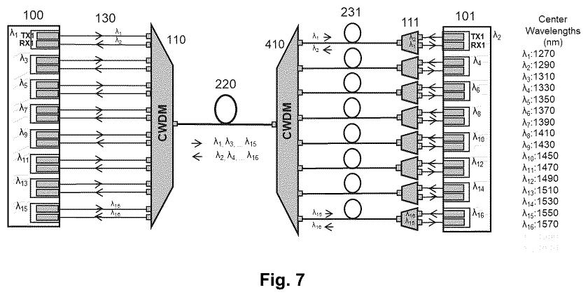

Embodiment 5, shown in FIG. 7, also uses different wavelengths at core and access network locations, however the innovation disclosed in this embodiment is the use of new type of CWDM module on the access side. Instead of using a standard 16 channel 20 nm ITU grid compliant CWDM module, a new CWDM with 40 nm channel spacing is proposed.

Similar to embodiment 4, embodiment 5 can also be constructed using circulators or isolator/splitter combinations instead of the 1×2 CWDMs, 111. For both embodiments 4 and 5, the core side cabling is constructed as duplex. However, if the core side cabling also must be in Bi-Di mode, optical components used in access side of the network (CWDM, circulators, isolators etc.) can be used in core side as well, by using the methods in the disclosure.

1. A system for implementing Bi-Di fiber optic LAN comprising:
A plurality of optical channels being transmitted over a same optical fiber by using wavelength division multiplexing and wherein at least one of the optical fiber channels in the have bi-directional transmission,
an access network side located in at least one of a zone distribution area or zone box
access network side cabling distributed across diverse physical distances with individual cable runs; and
optical Ethernet transceivers that do not require the high transmitting optical power and high receiver sensitivity typically.

2. The system for implementing Bi-Di fiber optic local area network according to claim 2 further comprising two CWDM modules on the core network side to multiplex a multiplicity of core network switch output ports with transceivers with distinct central wavelengths as specified in ITU CWDM grid further wherein one of the CWDM modules act as transmitter and the other module act as receiver,
a first broadband circulator to be used to combine transmit and receive multiplexed signals on a single fiber in a trunk cable of the LAN,
a second broadband circulator at the distribution layer of network to be used to route the transmit and receive signals; wherein the demultiplexed signals are combined port by port either sequentially or in a mixed pattern to form duplex signals for the access switch ports.

3. The system for implementing Bi-Di fiber optic local area network according to claim 2, where one or both of the broadband circulators are replaced by a combination of broadband isolator and broadband 1×2 50/50 splitter combination.

4. The system for implementing Bi-Di fiber optic local area network according to claim 1, further comprising two CWDM modules are on the core network side to multiplex a multiplicity of core network switch output ports with transceivers with distinct central wavelengths as specified in ITU CWDM grid, wherein one of the CWDM modules act as transmitter and the other module act as receiver, wherein a broadband circulator is used to combine transmit and receive multiplexed signals on a single fiber in a trunk cable of the LAN, where a second broadband circulator at the distribution layer of network is used to route the transmit and receive signals to two distribution layer network demultiplexer CWDM modules, one for transmit and the other one for receive, wherein the demultiplexed signals are combined with mixed ports using a 1×2 CWDM multiplexer module so that each combination has two distinct wavelength signals that match the CWDM module, where there is a multitude of ways to mix the ports which allows any core switch port to be connected to any available access switch port, where the multiplexed signals are sent over a single strand of fiber and received at the access switch side by a matching 1×2 CWDM demultiplexer which connects to the transmit and receive ports of the access switch transceiver ports, where the single strand of fiber in the access side cable operates in Bi-Di fashion.

5. The system for implementing Bi-Di fiber optic local area network according to claim 4, wherein core side cabling can be configured to be in Bi-Di mode by adding 1×2 CWDM multiplexers and demultiplexers before and after the core side cabling.

6. The system for implementing Bi-Di fiber optic local area network according to claim 4, where one or both of the broadband circulators are replaced by a combination of broadband isolator and broadband 1×2 50/50 splitter combination.

7. The system for implementing Bi-Di fiber optic local area network according to claim 1, further comprising two CWDM modules on a core network side to multiplex a multiplicity of core network switch output ports with transceivers with distinct central wavelengths as specified in ITU CWDM grid, where one of the CWDM modules act as transmitter and the other module act as receiver, where a broadband circulator is used to combine transmit and receive multiplexed signals on a single fiber in a trunk cable of the LAN, where a second CWDM module at the distribution layer of network is used to demultiplex individual port wavelengths in a Bi-Di fashion, where the demultiplexed ports are connected to distribution cabling in a Bi-Di fashion, where narrowband circulators are used to separate the transmit and receive paths to access switch port transceivers.

8. The system for implementing Bi-Di fiber optic local area network according to claim 7, where the broadband circulator is replaced by a combination of broadband isolator and broadband 1×2 50/50 splitter combination, where one or more of the narrowband circulators are replaced by narrowband isolator and narrowband 1×2 50/50 splitter combinations.

9. The system for implementing Bi-Di fiber optic local area network according to claim 7, where core side cabling can be configured to be in Bi-Di mode by implementing a method identical to what is used in distribution layer cabling by removing the broadband circulator and one of the core side CWDM module, and by adding narrowband circulators right after the core switch transceivers to separate transmit and receive signals.

10. The system for implementing Bi-Di fiber optic local area network according to claim 9, where one or more of the narrowband circulators in core and access side of the network are replaced by a combination of narrowband isolator and broadband 1×2 50/50 splitter combination.

11. The system for implementing Bi-Di fiber optic local area network according to claim 1, where a CWDM module is used on the core network side to multiplex a multiplicity of core network switch output ports with transceivers with distinct central wavelengths as specified in ITU CWDM grid, where transmit and receive ports of access switch transceivers are connected to consecutive CWDM wavelength ports, where core side cabling is used in duplex fashion, where common port of the core side CWDM module is connected to trunk cabling in Bi-Di fashion, where a second CWDM module is used at the distribution layer of network to demultiplex the signals for access layer ports, where 1×2 CWDM multiplexers are used to connect to distribution layer cabling and additional 1×2 CWDM modules are used to demultiplex so that transmit and receive signals are separated at the access switch side.

12. The system for implementing Bi-Di fiber optic local area network according to claim 11, where one or more of 1×2 CWDM modules are replaced by narrowband circulators.

13. The system for implementing Bi-Di fiber optic local area network according to claim 11, where one or more of 1×2 CWDM modules are replaced by narrowband isolator and 1×2 50/50 splitter combinations.

14. A method for implementing Bi-Di fiber optic local area network according to claim 1, where 1×2 CWDM multiplexers are used to connect core side switch port transceiver transmit and receive ports to core side cabling in a Bi-Di fashion, where additional 1×2 CWDM modules are used to demultiplex, where a CWDM module with multiplicity of wavelength ports is used on the core network side to multiplex these signals onto a trunk cable in a Bi-Di fashion, where a second CWDM module with multiplicity of wavelength ports is used at the distribution layer of network to demultiplex the signals for access layer ports, where 1×2 CWDM multiplexers are used to connect to distribution layer cabling and additional 1×2 CWDM modules are used to demultiplex so that transmit and receive signals are separated at the access switch side.

15. The system for implementing Bi-Di fiber optic local area network according to claim 14, where one or more of 1×2 CWDM modules are replaced by narrowband circulators.

16. The system for implementing Bi-Di fiber optic local area network according to claim 14, where one or more of 1×2 CWDM modules are replaced by narrowband isolator and 1×2 50/50 splitter combinations.

17. The system for implementing Bi-Di fiber optic local area network according to claim 1, where a CWDM module is used on the core network side to multiplex a multiplicity of core network switch output ports with transceivers with distinct central wavelengths as specified in ITU CWDM grid, where core side cabling is used in duplex fashion, where common port of the core side CWDM module is connected to trunk cabling in Bi-Di fashion, where a second CWDM module with non-standard 40 nm channel spacing is used at the distribution layer of network to demultiplex the signals for each wavelength pair per transceiver to connect to access layer ports, where 1×2 CWDM modules are used to demultiplex so that transmit and receive signals are separated at the access switch side.

18. The system for implementing Bi-Di fiber optic local area network according to claim 17, where one or more of 1×2 CWDM modules are replaced by narrowband circulators.

19. The system for implementing Bi-Di fiber optic local area network according to claim 18, where one or more of 1×2 CWDM modules are replaced by narrowband isolator and 1×2 50/50 splitter combinations.

20. The system for implementing Bi-Di fiber optic local area network according to claim 1, where 1×2 CWDM modules are used to multiplex the transmit and receive signals at core switch ports to connect to core cabling in Bi-Di fashion, where a CWDM module with non-standard 40 nm channel spacing is used on the core network side to multiplex a multiplicity of core network switch output ports onto trunk cabling in Bi-Di fashion, where a second CWDM module with non-standard 40 nm channel spacing is used at the distribution layer of network to demultiplex the signals for each wavelength pair per transceiver to connect to access layer ports, where 1×2 CWDM modules are used to demultiplex so that transmit and receive signals are separated at the access switch side.
